(19) United States
(12) Patent Application Publication
(10) Pub. No.: US 2003/0008662 A1
(43) Pub. Date: Jan. 9, 2003

(54) Systems and methods wherein a mobile user device operates in accordance with a location policy and user device information

(76) Inventors: Edith H. Stern, Yorktown Heights, NY (US); David P. Greene, Ossining, NY (US); Barry E. Willner, Briarcliff Manor, NY (US); Philip Shi-lung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 09/901,788

(22) Filed: Jul. 9, 2001

(51) Int. Cl. H04Q 7/20

(52) U.S. Cl. 455/456; 455/459

(57) ABSTRACT

Systems and methods are provided wherein a mobile user device operates in accordance with a location policy and user device information. According to one embodiment, a location policy associated with a location is determined. For example, a school may establish a location policy that prevents students from wirelessly exchanging information during class. User device information associated with a mobile user device is also determined. For example, it may be determined if the mobile user device is being used by a student or a teacher. It is then arranged for the mobile user device to operate in accordance with the location policy and the user device information.

### FIELD

The present invention relates to mobile user devices. In particular, the present invention relates to systems and methods wherein a mobile user device operates in accordance with a location policy and user device information.

### BACKGROUND

A person can use various types of mobile user devices in many different locations. For example, a person might bring a mobile communication device, such as a wireless telephone or two-way pager, to a movie theater or a hospital. As another example, a student or a teacher might bring a portable computing device, such as a laptop computer or Personal Digital Assistant (PDA), to his or her school. Similarly, a person might bring an information storage device, such as an audio recorder or a digital camera to a concert or a sporting event.

In some cases, however, the operation of a mobile user device can be inappropriate in view of the device's location. For example, when a person's wireless telephone rings in a movie theater other people can become annoyed and distracted. As another example, a student taking a test might unfairly receive information via his or her PDA (e.g., information to help him or her answer test questions). Similarly, the student might unfairly transmit information about the test to other students who will subsequently take the test. As other examples, a doctor might want to prevent a patient from communicating with others (e.g., while the patient is recuperating) and a confidential facility might want limit the types of information that can be received or transmitted by a visitor (e.g., to protect governmental or trade secrets).

It is known that wireless telephones can be prevented from operating correctly within a certain area. For example, a movie theater can physically “jam” the frequencies and signals used by wireless telephones to prevent them from operating. Similarly, a device associated with a movie theater may wirelessly instruct a telephone to prevent it from ringing. However, theses approaches may prevent all wireless telephones from operating, perhaps including those used by employees of the movie theater and emergency personnel (e.g., a paramedic helping someone at the movie theater or a doctor who needs to receive emergency telephone calls). Moreover, such an approach prevents all types of communications (e.g., including a telephone call from a babysitter to a parent who is at a movie theater).

Such approaches also do not allow for dynamic management of mobile user devices. For example, a school couldn't let a teacher send and receive Instant Messages (IM) while preventing a student from doing so while he or she is taking a test. Similarly, a concert promoter could not prevent some members in an audience from taking pictures while allowing others to do so (e.g., others who had previously subscribed to a service that allows them to take such pictures).

### SUMMARY

To alleviate problems inherent in the prior art, the present invention introduces systems and methods wherein a mobile user device operates in accordance with a location policy and user device information.

According to one embodiment, a location policy associated with a location is determined. User device information associated with a mobile user device is also determined and it is arranged for the mobile user device to operate in accordance with the location policy and the user device information.

According to another embodiment, a location policy associated with a location is established, and a device policy is received from a wireless communication device. The location policy is then compared with the device policy, and information is transmitted to arrange for the wireless communication device to communicate in accordance with the location policy and the device policy.

According to still another embodiment, a user device policy associated with a mobile user device is determined. Location information associated with a location is also determined, and it is arranged for the mobile user device to operate in accordance with the user device policy and the location information.

According to yet another embodiment, a location policy associated with a location is determined along with a user device policy associated with a mobile user device. It is then arranged for the mobile user device to operate in accordance with the location policy and/or the user device policy.

Another embodiment is directed to systems and methods wherein a third-party service facilitates operation of a mobile user device at a location. According to this embodiment, an indication of a location policy associated with the location is received along with user device information associated with the mobile user device. Information is then transmitted to arrange for the mobile user device to operate in accordance with the location policy and the user device information.

One embodiment of the present invention comprises: means for determining a location policy associated with a location; means for determining user device information associated with a mobile user device; and means for arranging for the mobile user device to operate in accordance with the location policy and the user device information.

Another embodiment comprises: means for establishing a location policy associated with a location; means for receiving a device policy from a wireless communication device; means for comparing the location policy with the device policy; and means for transmitting information to arrange for the wireless communication device to communicate in accordance with the location policy and the device policy.

Still another embodiment comprises: means for determining a user device policy associated with a mobile user device; means for determining location information associated with a location; and means for arranging for the mobile user device to operate in accordance with the user device policy and the location information.

Yet another embodiment comprises: means for determining a location policy associated with a location; means for determining a user device policy associated with a mobile user device; and means for arranging for the mobile user device to operate in accordance with at least one of: (i) the location policy, and (ii) the user device policy.

Another embodiment is associated with a third-party service and comprises: means for receiving an indication of a location policy associated with a location; means for receiving user device information associated with a mobile user device; and means for transmitting information to arrange for the mobile user device to operate in accordance with the location policy and the user device information.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram according to an embodiment of the present invention.

FIG. 2 is a block diagram overview of a communication system according to an embodiment of the present invention.

FIG. 3 is a flow chart of a method according to an embodiment of the present invention.

FIG. 4 is a block diagram of a mobile user device according to an embodiment of the present invention.

FIGS. 5 through 7 illustrate mobile user devices according to some embodiments of the present invention.

FIG. 8 is a tabular representation of a portion of a user device policy database according to an embodiment of the present invention.

FIG. 9 is a tabular representation of a portion of a user device operation status database according to an embodiment of the present invention.

FIG. 10 is a block diagram of a location device according to an embodiment of the present invention.

FIG. 11 is a tabular representation of a portion of a location policy database according to an embodiment of the present invention.

FIG. 12 is a tabular representation of a portion of a location operation status database according to an embodiment of the present invention.

FIG. 13 is a flow chart of a computer-implemented method to facilitate operation of a wireless communication device at a location according to an embodiment of the present invention.

### DETAILED DESCRIPTION

Embodiments of the present invention are associated with “mobile user devices.”

As used herein, the phrase “mobile user device” refers to any device that can be operated by a user at various locations. A mobile user device may be, for example, a communication device such as a wireless telephone or a pager (e.g., a one-way or two-way pager). A mobile user device may also be, for example, a computing device, such as a PDA or laptop computer. A mobile user device may also be an information storage device, such as an audio recording device or an image recording device (e.g., a digital camera or a video camera).

In addition, embodiments of the present invention are associated with “locations.”As used herein, the term “location” can refer to any area or region. A location may be, for example, associated with a proximity to a location device (e.g., within two hundred feet of a transmitter), a location boundary (e.g., within a building). Examples of locations include schools, hospitals, and event areas (e.g., a movie theater or sporting area). Note that a location may be mobile (e.g., a location defined as an area within two hundred feet of an emergency vehicle) and/or may comprise a plurality of discrete locations (e.g., a number of classrooms in a school). A location may also be defined, for example, using one or more latitudes, longitudes, map identifiers (e.g., locations “C3” on a map grid), and/or street identifiers. Also note that a location may be defined in two or three dimensions (e.g., a location may comprise the fifth through the ninth floors of an office building).

Embodiments of the present invention are directed to systems and methods wherein a mobile user device operates in accordance with a location “policy” and user device information. As used herein, the term “policy” refers to any rule or other type of information that can be associated with the operation of a mobile user device. A policy may indicate, for example, that a mobile user device cannot transmit information. As another example, a policy may indicate that only certain types of information are allowed to be received or recorded by a mobile user device.

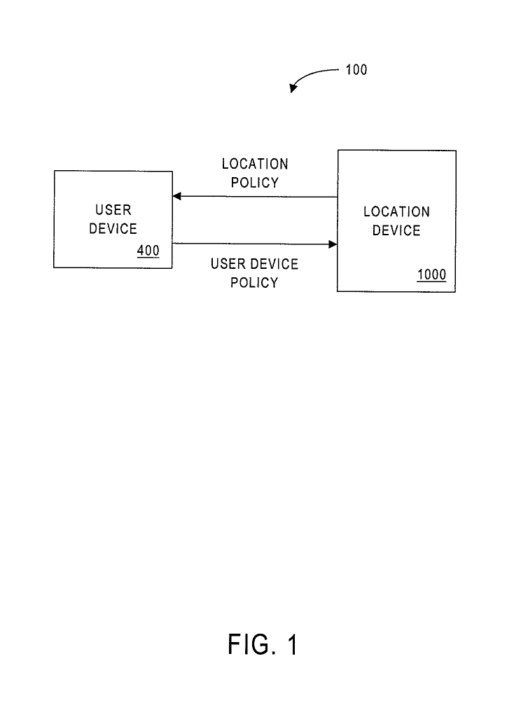

Turning now in detail to the drawings, FIG. 1 is an information flow diagram 100 according to one embodiment of the present invention. As shown in FIG. 1, a user device 400 may receive a location policy from a location device 1000. For example, the location device 1000 might transmit the following location policy to a digital audio recorder: “no information is to be recorded at this location until a new location policy is established.”According to another embodiment, the location device 1000 transmits other information associated with the operation of the user device 400. For example, the location device 1000 might transmit a location identifier (e.g., indicating that the user device 400 is now in a school) or a pointer that lets the user device 400 access an appropriate policy (e.g., from a third-party service, such as a cellular telephone provider).

As is also shown in FIG. 1, the location device 1000 may receive a user device policy from the user device 400. For example, the location device 1000 may receive the following user device policy from a digital video camera: “this device is authorized to record up to five minutes of information at this location.” Note that the location device 1000 might instead receive a user policy (i.e., a policy associated with a particular user instead of a particular device) from the user device 400.

According to another embodiment, the location device 1000 receives other information associated with the operation of the user device 400. For example, the location device 1000 may receive information identifying a particular user or a user category (e.g., a “student” user or a “teacher” user).

Note that information may be transmitted in only a single direction according to one embodiment of the present invention. For example, the location device 1000 may transmit information to the user device 400 without receiving information from the user device 400. Similarly, the location device 1000 may receive information from the user device 400 without transmitting information to the user device 400. According to another embodiment, information is transmitted in both directions (i.e., there is an exchange of information between the location device 1000 and the user device 400). For example, the user device 400 and the location device 1000 might exchange information while negotiating an appropriate policy. Note that any number of devices may be involved with information exchanged in FIG. 1. For example, a mobile user device 400, a location device 1000 (e.g., that broadcasts a location identifier), and a server in a communication network that communicates with the mobile user device 400 and/or the location device 1000 (e.g., to associate the location of the mobile user device 400 with an appropriate policy).

Communication System Overview

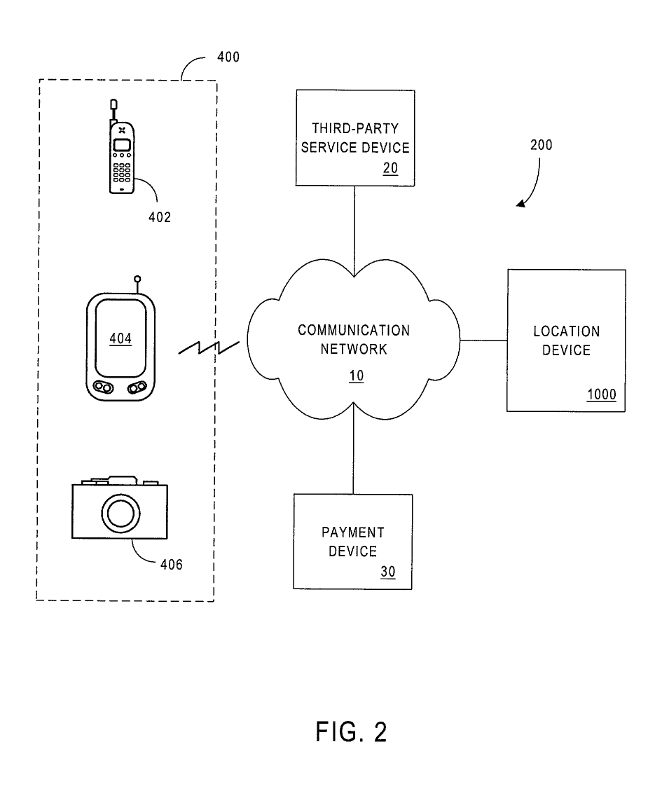

FIG. 2 is a block diagram of a communication system 200 according to one embodiment of the present invention. The communication system 200 includes a location device 1000 in communication with a number of mobile user devices 400. As used herein, devices (such as the location device 1000 and the mobile user devices 400) may communicate via a communication network 10, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), an Infrared Radiation (IR) network, or an Internet Protocol (IP) network such as the Internet, an intranet or an extranet. As used herein, the term “communications” can refer to wired and/or wireless communications as appropriate.

For example, the location device 1000 may communicate with a mobile user device 400 using Bluetooth technology. Bluetooth technology allows a wide range of computing and telecommunication devices to be interconnected via wireless connections. Specifications and other information regarding Bluetooth technology are available at the Bluetooth Web site www.bluetooth.com. In embodiments utilizing Bluetooth technology, communicating devices may be equipped with a microchip transceiver that transmits and receives information in a frequency band of 2.45 GHz (with some variation of bandwidth in different countries). Connections may be point-to-point or multipoint over a maximum range, such as ten meters. Embodiments using Bluetooth technology may require the additional use of one or more communication stations (e.g., a number of communication stations may be positioned throughout a location, and a communication station may relay information between the location device 1000 and one or more mobile user devices 400).

Although a single location device 1000 is shown in FIG. 2, any number of location devices 1000 may be included in the communication system 200. Similarly, any number of mobile user devices 400, or any of the other devices described herein, may be included in the communication system 200 according to embodiments of the present invention.

The location device 1000 and the mobile user devices 400 may be any devices capable of performing the various functions described herein. The mobile user device 400 may be, for example: a wireless telephone 402, a PDA 404, or an information storage device 406. Note that the information storage device 406 may record information (e.g., as with a digital camera) and/or provide information (e.g., as with a digital music player).

Note that the devices shown in FIG. 2 need not be in constant communication. For example, the location device 1000 may communicate with a mobile user device 400 on an as-needed or periodic basis. Similarly, the location device 1000 might communicate with a mobile user device 400 only when the mobile user device 400 is located near the location device 1000.

According one embodiment of the present invention, the location device 1000 determines a location policy associated with a location. For example, an authority associated with a location may establish one or more policies associated with the operation of mobile user devices 400 at that location. Consider a testing service, such as a service associated with a standardized test that is administered to students. In this case, the testing service may indicate to the location device 1000 that mobile user devices 400 associated with students cannot receive or transmit information at a location where a test is being administered.

The location device 1000 may also determine user device information associated with the mobile user device 400 (e.g., associated with the device itself or with a user operating the device). For example, the location device 1000 may receive a user identifier from the mobile user device 400 and determine whether the user identifier is associated with a student or a test administrator.

The location device 1000 may also arrange for the mobile user device 400 to operate in accordance with the location policy and the user device information. For example, the location device 1000 may transmit an appropriate location policy to the mobile user device 400 based on a user identifier.

According to one embodiment, the location device 1000 and/or the mobile user device 400 also determines a current location associated with the mobile user device 400. For example, a mobile user device 400 may be assumed to be within a location whenever it is able to communicate with a location device 1000. Similarly, the distance between a location device 1000 and a mobile user device 400 may be calculated (e.g., based on signal strength) to determine whether or not the mobile user device is within a location. According to another embodiment, a mobile user device 400 determines a current location by accessing Global Positioning System (GPS) information. In still another embodiment, information from a third-party service, such as a cellular telephone provider, is used to determine a current location associated with a mobile user device 400.

In addition to the location device 1000 and the mobile user device 400, a third-party service device 20 can facilitate a policy determination. For example, the third-party service device 20 may receive both (i) an indication of a location policy associated with a location and (ii) user device information associated with a mobile user device 400. The third-party service device 20 can then transmit information to arrange for the mobile user device 400 to operate in accordance with the location policy and the user device information. According to another embodiment, the third-party service device 20 stores user profile information. In this way, information about a user can be accessed by a number of different mobile user devices 400 and/or location devices 1000.

The location device 1000 and/or the mobile user device 400 may further arrange for an exchange of payment associated with operation of the mobile user device 400. For example, the location device 1000 may communicate with a payment device 30 to arrange for a user to provide payment (e.g., via his or her credit card account, debit card account, banking account, or a digital payment protocol) based on the operation of the mobile user device 400 (e.g., the user may be charged one dollar for each picture he or she takes with a digital camera). As another example, the third-party service device 20 may arrange to receive payment from a user or a location (e.g., a movie theater) in exchange for facilitating the operation of the mobile user device 400 at the location.

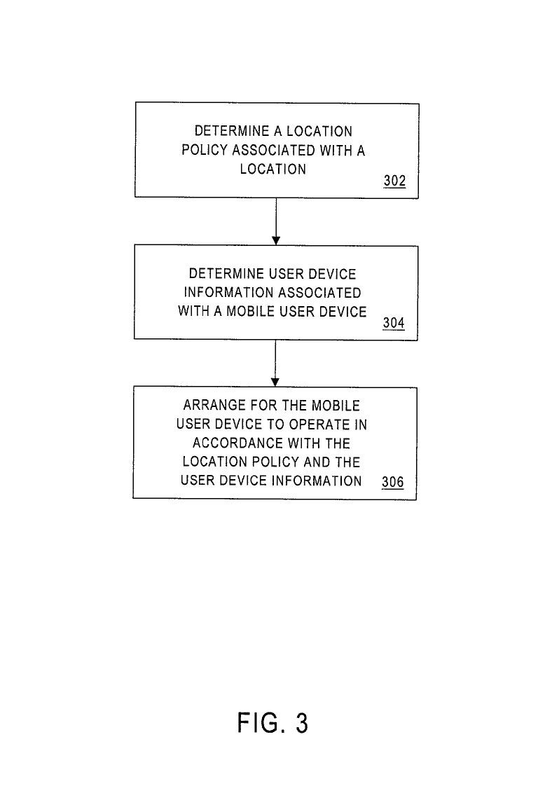

FIG. 3 is a flow chart of a method according to an embodiment of the present invention. The flow charts in FIG. 3 and the other figures described herein do not imply a fixed order to the steps, and embodiments of the present invention can be practiced in any order that is practicable. The method shown in FIG. 3 may be performed, for example, by the location device 1000, a mobile user device 400, and/or a third-party service device 20.

At 302, a location policy associated with a location is determined. The location may be, for example, determined based on proximity to a location device 1000 (e.g., a location may be defined as an area within one hundred feet of a location device 1000). A location may also be associated with a location boundary, such as the walls of an education area (e.g., a school) or a health care area (e.g., a hospital). Note that a location may be mobile (e.g., an airplane) and/or comprise a plurality of locations (e.g., a number of different classrooms within a school). A location may also be associated with a date and/or a time (e.g., a location may be defined as the area within a sports stadium while a sporting event occurs).

The location policy may be determined, for example, when a pre-stored location policy is retrieved by a location device 1000 (e.g., from a database maintained by an operator associated with the location). A location policy may also be determined by evaluating a plurality of potential location policies, such as when a mobile user device 400 is simultaneously located in two different locations (e.g., a “shopping mall” location and a particular “store” location within the shopping mall). An indication of a location policy may also be received via a third-party service device 20 (e.g., a policy definition service).

According to another embodiment, an indication of a location policy is received from a location device 1000 (e.g., a mobile user device 400 can receive the location policy from the location device 1000). As used herein, an “indication” of a location policy may comprise, for example, the location policy itself (e.g., as defined by a Java applet). The indication can also comprise a location identifier (e.g., an identifier indicating that a location is a “concert hall”). According to another embodiment, the indication is associated with a policy identifier (e.g., mobile user devices 400 may recognize that policy “P101” is associated with a pre-defined set of rules). In still other embodiments, the indication can comprise a pointer to a location policy (e.g., an IP address at which the location policy is stored) and/or payment information.

At 304, user device information associated with a mobile user device 400 is determined. The user device information may comprise, for example, information associated with a mobile user device 400 (e.g., indicating whether or not a wireless telephone has an audible ringer). The user device information may also be associated with a user (e.g., indicating that the user is a police officer).

The user device information may be a user device policy. For example, the user device information may be a set of rules or priorities associated with the mobile user device 400 (e.g., indicating that the device needs to be able receive telephone calls from a pre-determined telephone number).

According to one embodiment, the user device information is an indication associated with a user device policy. The indication may comprise, for example, the user device policy itself, a user identifier, or a user category (e.g., indicating that a user is a “doctor”). According to another embodiment, the indication is associated with a policy identifier (e.g., a location device 1000 may recognize that policy “P101” is associated with a pre-defined set of rules). In still other embodiments, the indication may comprise a pointer to a location policy and/or payment information (e.g., the user's credit card number or subscription information).

According to one embodiment, the user device information simply indicates whether or not a user device is capable of understanding (and operating in accordance with) a location policy. By way of example, only a “qualified” mobile user devices 400 might be allowed in an auditorium during a standardized test (e.g., a device that is certified as having the necessary hardware and/or software to ensure compliance with a location policy). In this case, a qualified device might be recognized based on a manufacturer, a model number, or a logo imprinted on the device or displayed on the device's screen.

The user device information may be determined, for example, when a location device 1000 receives information from a mobile user device 400 or when pre-stored user device information is retrieved by a mobile user device 400 (e.g., from a database created by a manufacturer or maintained by a user). A mobile user device 400 may also receive an indication of user device information (e.g., by receiving a policy from a user or a third-party service device 20).

At 306, it is arranged for the mobile user device 400 to operate in accordance with the location policy and the user device information. For example, a location device 1000 may evaluate user device information and transmit an appropriate location policy to a mobile user device 400. Consider a location device 1000 associated with a school that lets teachers wirelessly exchange information but prevents students from doing so. In this case, the location device 1000 may receive user device information from a PDA indicating that the PDA is registered to a student. The location device 1000 can compare the registration information with the location policy and transmit information to the PDA indicating that the PDA is not allowed to wirelessly exchange information.

Note that the location device 1000 might simply determine whether or not a location policy will be applied based on the user device information. According to another embodiment, a location device 1000 and a mobile user device 400 negotiate an acceptable policy to be applied. For example, the location device 1000 may initially instruct a digital camera that no pictures are to be taken during a concert performance. The digital camera may then transmit an offer to provide payment of five dollars in exchange for permission to take ten pictures. The location device 1000 can then reject the offer, accept the offer, or propose a counter-offer to the digital camera. According to still another embodiment, it is determined whether a location policy or a user device policy has priority. For example, a user device policy associated with a police officer might have priority over a location policy associated with a museum, which in turn has priority over a user device policy associated with an ordinary citizen.

The location device 1000 and/or a third-party service device 20 may also verify that a mobile user device 400 is operating in accordance with a location policy and/or user device information. Consider, for example, school's location device 1000 that instructs a PDA to not exchange information from 8:00 AM to 3:00 PM. In this case, the location device 1000 may attempt to transmit a test message to the PDA at 8:30 AM to ensure that the message is rejected (e.g., to discourage students from altering the PDA's software and/or hardware to enable communication during school hours).

As a result of the steps illustrated in FIG. 3, a mobile user device 400 will “operate” in accordance with a location policy and/or user device information. For example, the mobile user device 400 may receive, store, or transmit information in accordance with an appropriate policy. As another example, the mobile user device 400 may provide information to a user in accordance with an appropriate policy. For example, a student's PDA might be allowed to receive an electronic mail message during a test—but be prevented from displaying the message to the student until after the test is over. As another example, a digital music player may be allowed to provide information to a user (e.g., by playing music) at only a certain volume while at a location (e.g., while at a public beach equipped with a location device 1000).

Note that all of the steps illustrated in FIG. 3 may be performed by a single device (e.g., a mobile user device 400, a location device 1000, or a third-party service device 20) or different steps may be performed by different devices, including any of the devices shown in FIG. 3.

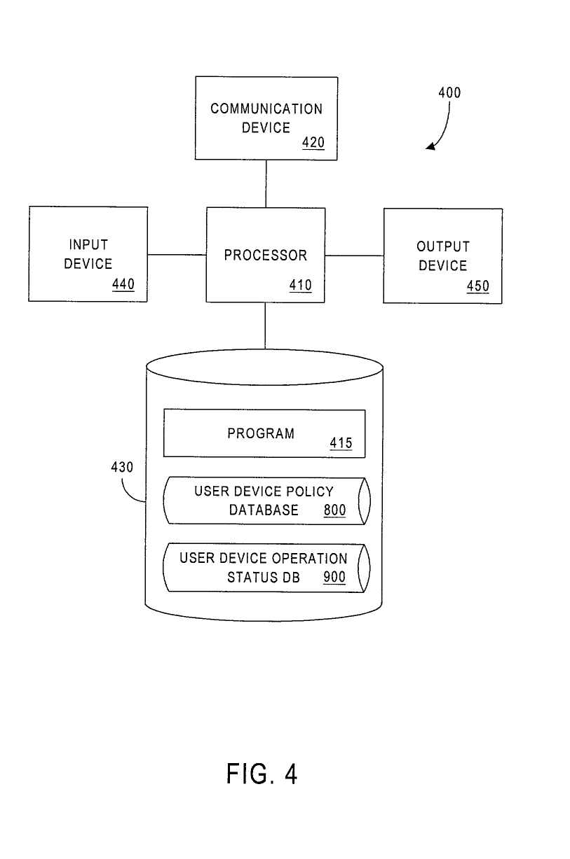

Examples of devices that may be used in connection with the communication system 200 discussed herein will now be described in detail with respect to FIGS. 4 through 12.

Mobile User Device

FIG. 4 illustrates a mobile user device 400 that is descriptive of the devices shown, for example, in FIG. 2 according to an embodiment of the present invention. The mobile user device 400 comprises a processor 410, such as one or more INTEL® Pentium® processors, coupled to a communication device 420 configured to communicate via a communication network (not shown in FIG. 4). The communication device 420 may be used to communicate, for example, with other mobile user devices 400, a location device 1000, a third-party service device 20, and/or a payment device 30.

The processor 410 is also in communication with an input device 440. The input device 440 may comprise, for example, a keyboard, a mouse or other pointing device, a microphone, knob or a switch, an IR port, a docking station, and/or a touch screen. Such an input device 440 may be used, for example, to enter information (e.g., information to be transmitted, a user identifier, or a user policy).

The processor 410 is also in communication with an output device 450. The output device 450 may comprise, for example, a display (e.g., a display screen), a speaker, and/or a printer. The output device 450 may be used, for example, to indicate received information (e.g., an electronic mail message) or a currently active location policy to a user (e.g., to explain why the mobile user device 400 is operating in a particular way).

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 stores a program 415 for controlling the processor 410. The processor 410 performs instructions of the program 415, and thereby operates in accordance with the present invention. For example, the processor 410 may determine a location policy associated with a location (e.g., by receiving the location policy from a location device 1000). The processor 410 may also determine user device information associated with the mobile user device 400 (e.g., by receiving the information from the user via the input device 440 or by retrieving pre-stored information) and arrange for the mobile user device 400 to operate in accordance with the location policy and the user device information (e.g., by limiting the information that may be displayed via the output device 450).

According to another embodiment, the processor 410 determines a user device policy associated with the mobile user device 400 along with location information associated with a location (e.g., by receiving the location information from a location device 1000). The processor 410 then arranges for the mobile user device 400 to operate in accordance with the user device policy and the location information.

According to still another embodiment, the processor 410 determines a user device policy associated with the mobile user device 400 along with a location policy associated with a location (e.g., by receiving the location policy from a location device 1000). The processor 410 then arranges for the mobile user device 400 to operate in accordance with the user device policy and/or the location policy.

As used herein, information may be “received” by or “transmitted” to, for example: (i) the mobile user device 400 from the location device 1000; or (ii) a software application or module within the mobile user device 400 from another software application, module, or any other source.

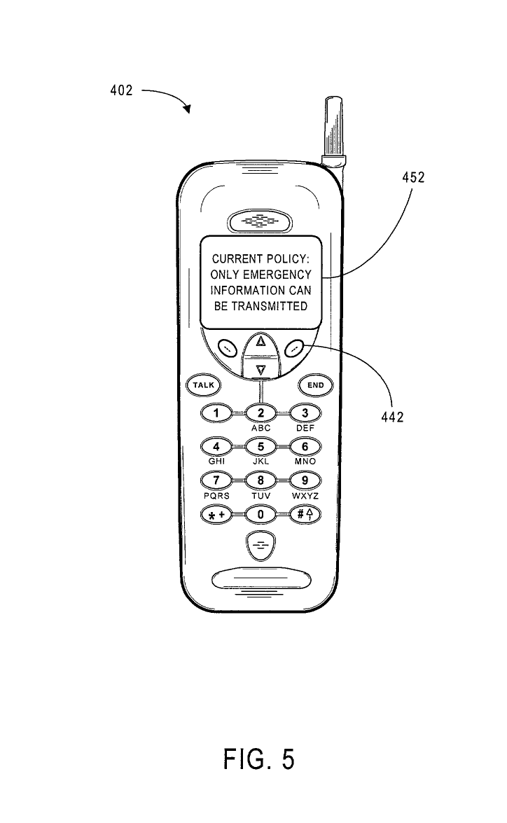

By way of example, FIG. 5 illustrates a wireless telephone 402 according to an embodiment of the present invention. The wireless telephone 402 includes an input device 442 and an output device 452 displaying a currently active location policy to a user. In this example, the user is only allowed to make a wireless telephone call to emergency telephone numbers (e.g., “911” or other emergency telephone numbers). Such a notification will let a user understand why he or she is unable to make telephone calls to other telephone numbers.

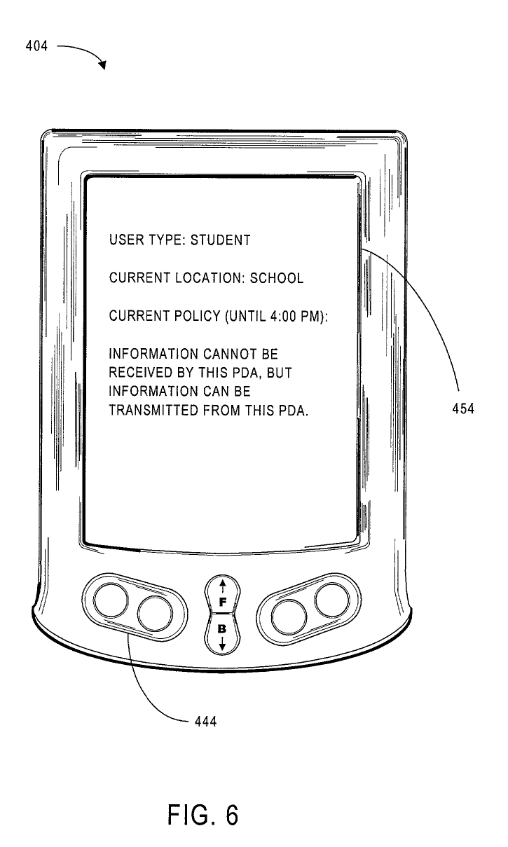

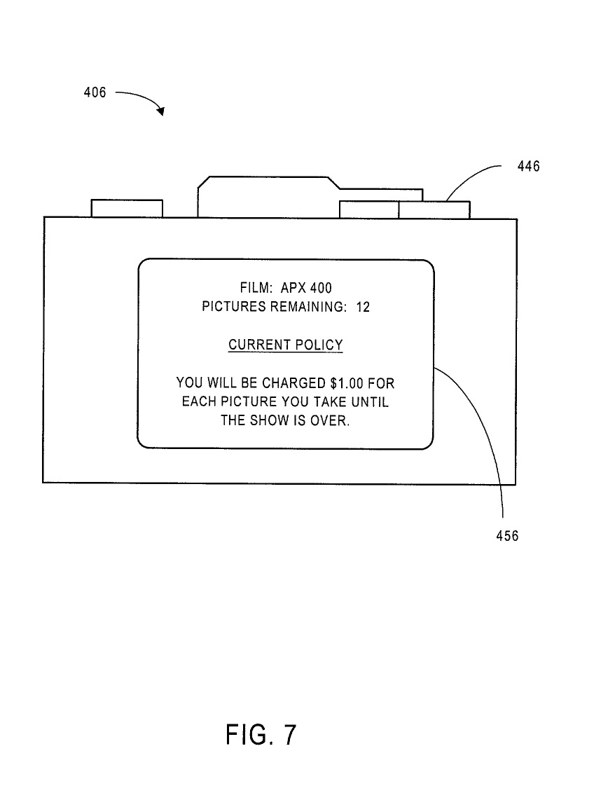

As another example, FIG. 6 illustrates a PDA 404 according to another embodiment of the present invention. The PDA 404 includes an input device 444 that can be used, for example, to enter a user identifier and password. The PDA 404 also includes an output device 454 (e.g., a display screen) indicating a currently active location policy to the user. Similarly, FIG. 7 illustrates a digital camera including an input device 446 and an output device 456 displaying a currently active location policy.

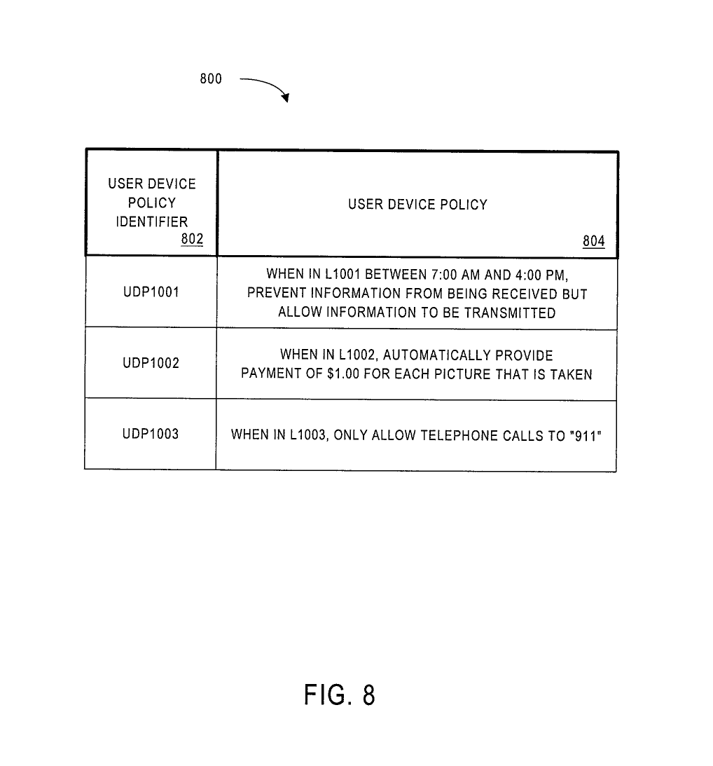

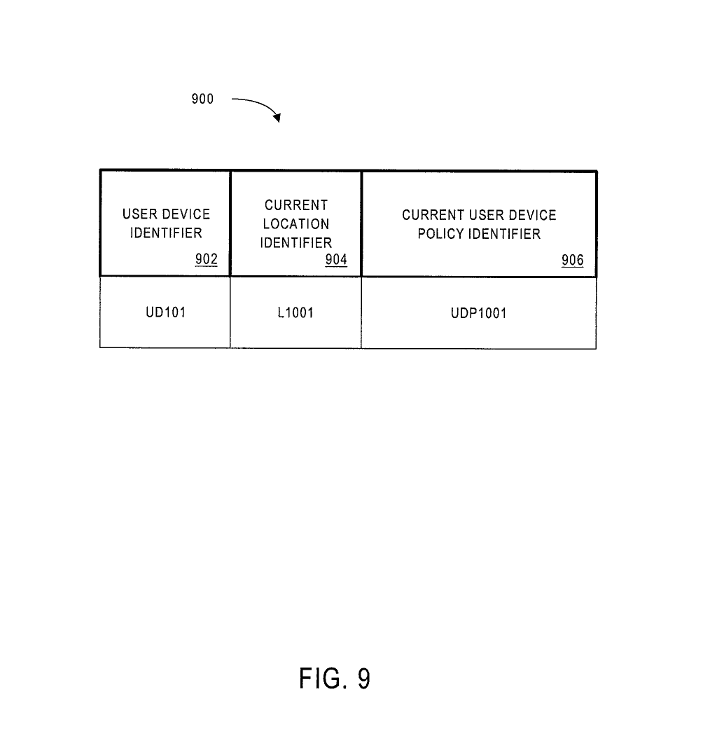

Referring again to FIG. 4, the storage device 430 also stores a user device policy database 800 (described with respect to FIG. 8) and a user device operation status database 900 (described with respect to FIG. 9). The illustrations and accompanying descriptions of the databases presented herein are exemplary, and any number of other database arrangements could be employed besides those suggested by the figures.

User Device Policy Database

Referring to FIG. 8, a table represents the user device policy database 800 that may be stored at a mobile user device 400 according to an embodiment of the present invention. According to another embodiment, this information may instead be stored at a third-party service device 20.

The table includes entries identifying policies that may control the operation of a mobile user device 400. The table also defines a user device policy identifier 802 and a user device policy 804 for each of the entries. The information in the user device policy database 800 may be created and updated, for example, by a manufacturer, a user, or a location device 1000.

The user device policy identifier 802 may be, for example, an alphanumeric code associated with a particular policy. The user device policy 804 defines one or more rules associated with the user device policy. For example, as illustrated by the second entry in the table, a user may automatically provide payment of one dollar for each picture that is taken by a mobile user device 400. The user device policy 804 may be defined, for example, by a user, a location device 1000. The user device policy 804 may also be negotiated between a user (or a mobile user device 400) and a location device 1000. According to one embodiment, the user device policy 804 represents a potential user device policy that will be proposed to location devices (e.g., “I want to be allowed to receive an emergency telephone call from my home telephone number”).

In addition to the information illustrated in FIG. 8, other information can also be stored in the user device policy database 800. For example, a list of telephone numbers that a user may place telephone calls to (or receive telephone calls from) may be stored. Similarly, a list of “pre-approved” Web sites may be stored in the user device policy database 800 (e.g., Web sites that students will be allowed to access while at school).

User Device Operation Status Database

Referring to FIG. 9, a table represents the user device operation status database 900 that may be stored at a mobile user device 400 according to an embodiment of the present invention. The table includes one or more entries identifying the policies that currently control the operation of the mobile user device 400. The table also defines fields 902, 904, 906 for each of the entries. The fields specify: a user device identifier 902, a current location identifier 904, and a current user device policy identifier 906. The information in the user device operation status database 900 may be created and updated, for example, as a mobile user device 400 moves from location to location.

The user device identifier 902 may be, for example, an alphanumeric code associated with a particular mobile user device 400 (or a particular user, such as when multiple users may be associated with a single device or when a single user may be associated with multiple devices). The current location identifier 904 indicates where the mobile user device 400 is currently located.

The current user device policy identifier 906 may be an alphanumeric code associated with one or more rules that currently control the operation of the mobile user device 400. The current user device policy identifier 906 may be based on, or associated with, the user device policy identifier 802 stored in the user device policy database 800. For example, as illustrated by the first entry in the table, the device can transmit, but not receive, information between 7:00 AM and 4:00 PM (i.e., as defined by the current user device policy identifier 906 and the associated user device policy 804). Note that the current user device policy identifier 906 may be determined at least in part by the current location identifier 904 (e.g., a device may be allowed to transmit, but not receive, information because it is currently located in “L1100”).

Note that multiple user device policies might simultaneously control the operation of a mobile user device 400. Consider, for example, a mobile user device 400 that acts as both a wireless telephone 402 and a digital camera 406. In this case, one user device policy could control how the device communicates information while another controls how the device stores information.

Location Device

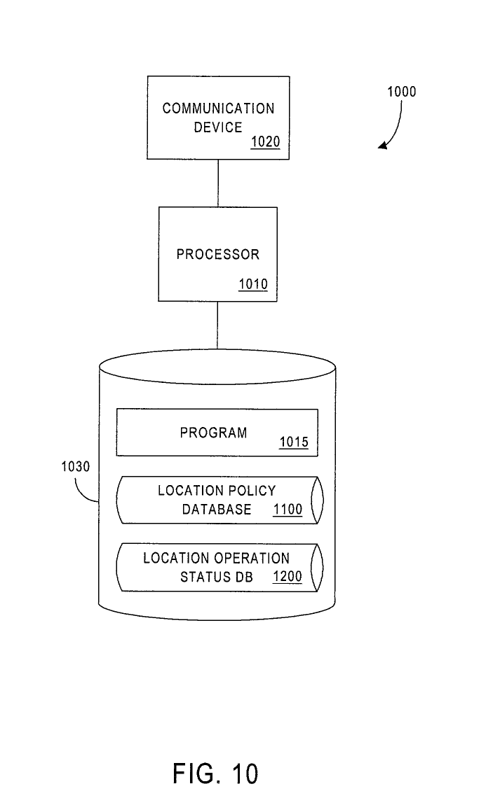

FIG. 10 illustrates a location device 1000 that is descriptive of the device shown, for example, in FIG. 2 according to an embodiment of the present invention. The location device 400 comprises a processor 1010, such as one or more INTEL® Pentium® processors, coupled to a communication device 1020 configured to communicate via a communication network (not shown in FIG. 10). The communication device 1020 may be used to communicate, for example, with one or more mobile user devices 400, third-party service devices 20, and/or payment devices 30.

The processor 1010 is also in communication with a storage device 1030. The storage device 1030 may comprise any appropriate information storage device, including combinations of magnetic storage devices, optical storage devices, and/or semiconductor memory devices (such as RAM devices and ROM devices).

The storage device 1030 stores a program 1015 for controlling the processor 1010. The processor 1010 performs instructions of the program 1015, and thereby operates in accordance with the present invention. For example, the processor 1010 may determine a location policy associated with a location along with user device information associated with a mobile user device 400 (e.g., by receiving the user device information from the mobile user device 400). The processor 1010 may then arrange for the mobile user device 400 to operate in accordance with the location policy and the user device information (e.g., by transmitting an appropriate policy to the mobile user device 400).

According to another embodiment, the processor 1010 establishes a location policy associated with a location (e.g., after receiving information from an operator associated with the location). The processor 1010 receives a device policy from a wireless communication device and compare the location policy with the device policy. The processor 1010 then transmits information to arrange for the wireless communication device to communicate in accordance with the location policy and the device policy.

According to still another embodiment, the processor 1010 determines a user device policy associated with a mobile user device 400 along with location information associated with a location. The processor 1010 then arranges for the mobile user device 400 to operate in accordance with the user device policy and the location information. According to yet another embodiment, the processor 1010 determine a location policy associated with a location along with a user device policy associated with a mobile user device 400. The processor 1010 then arranges for the mobile user device 400 to operate in accordance with the location policy and/or the user device policy.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the location device 1000 from a mobile user device 400; or (ii) a software application or module within the location device 1000 from another software application, module, or any other source.

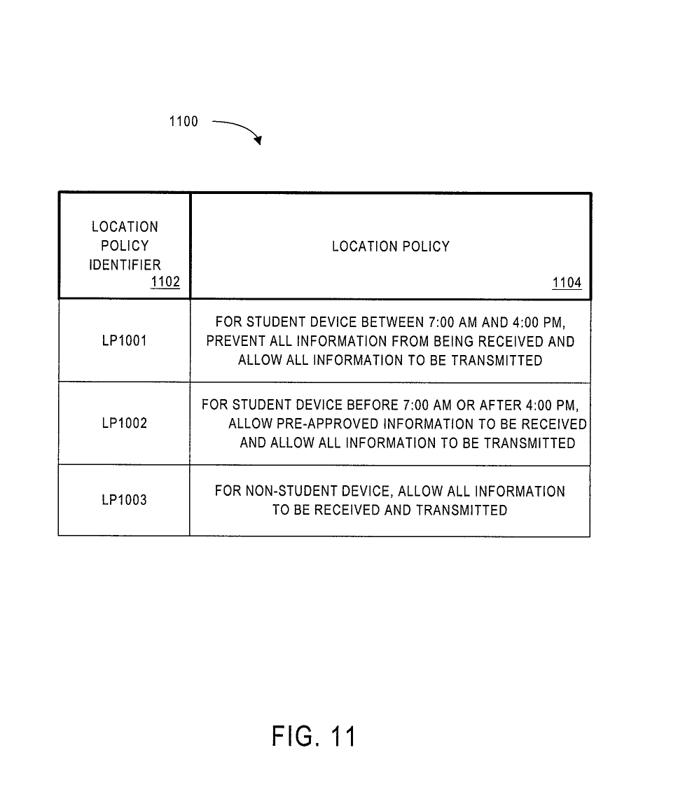

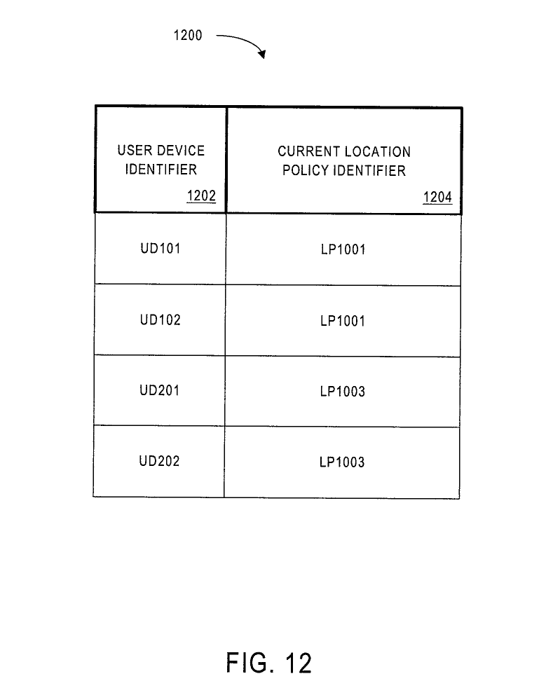

As shown in FIG. 10, the storage device 1030 also stores a location policy database 1100 (described with respect to FIG. 11) and a location operation status database 1200 (described with respect to FIG. 12).

Location Policy Database

Referring to FIG. 11, a table represents the location policy database 1100 that may be stored at a location device 1000 according to an embodiment of the present invention. According to another embodiment, this information may instead be stored at a third-party service device 20.

The table includes entries identifying policies that may control the operation of a mobile user device 400. The table also defines a location policy identifier 1102 and a location policy 1104 for each of the entries. The information in the location policy database 1100 may be created and updated, for example, by a manufacturer (e.g., that provides location devices to hospitals) or an operator associated with a location.

The location policy identifier 1102 may be, for example, an alphanumeric code associated with a particular policy. The location policy 1104 may define one or more rules associated with the location policy. For example, as illustrated by the third entry in the table, a non-student device may be allowed to receive and transmit all types of information. Note that the location policy 1104 may be defined, for example, by an operator associated with a location, a mobile user device 400 (e.g., a police officer's wireless telephone), or be negotiated between a user (or a mobile user device 400) and a location device 1000. According to one embodiment, the location policy 1104 represents a potential location policy that will be proposed to mobile user device 400 (e.g., “you may record digital video images in exchange for paying one dollar per minute”).

Location Operation Status Database

Referring to FIG. 12, a table represents the location operation status database 1200 that may be stored at a location device 1000 according to an embodiment of the present invention. The table includes one or more entries identifying policies that currently control mobile user devices 400 at a location. The table also defines a user device identifier 1202 and a current location policy identifier 1204 for each of the entries. The information in the location operation status database 1200 may be created and updated, for example, as mobile user devices 400 enter and leave a location.

The user device identifier 1202 may be, for example, an alphanumeric code associated with a particular mobile user device 400 (or a particular user). The user device identifier 1202 may be based on, or associated with, the user device identifier 902 stored in the user device operation status database 900.

The current location policy identifier 1204 may be an alphanumeric code associated with one or more rules that currently control operation of the mobile user device 400. The current location policy identifier 1204 may be based on, or associated with, the location policy identifier 1102 stored in the location policy database 1100.

Communication System Method

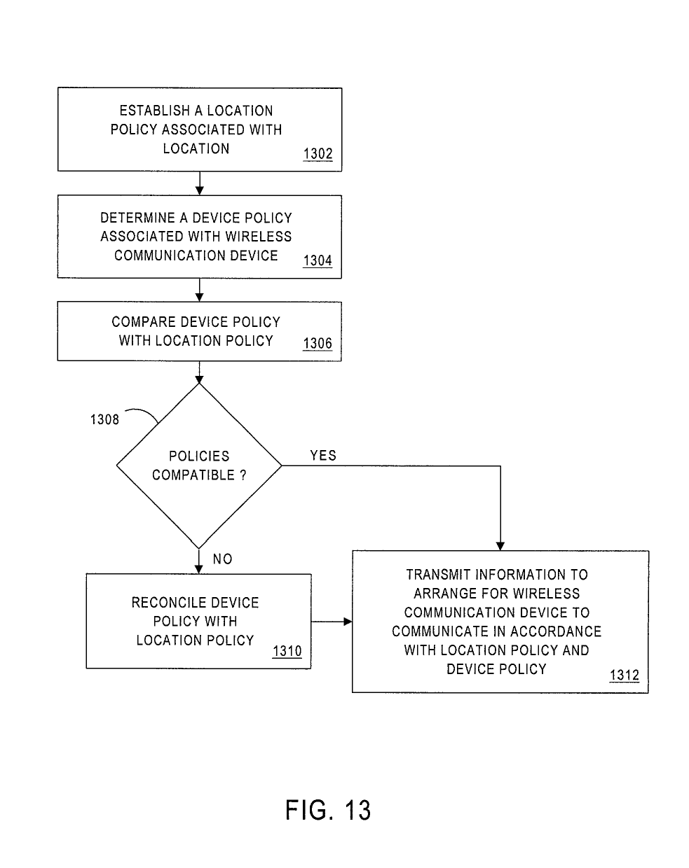

FIG. 13 is a flow chart of a computer-implemented method to facilitate operation of a wireless communication device at a location according to an embodiment of the present invention. The method may be performed, for example, by a location device 1000.

At 1302, a location policy associated with a location is established. For example, the location device 1000 may receive information about one or more appropriate policies from an operator associated with the location. A location policy may also be established, for example, by retrieving a location policy 1104 from the location policy database 1100.

At 1304, a device policy associated with a wireless communication device is determined. For example, information about the device policy may be received from the wireless communication device. The device policy is then compared with the location policy device policy at 1306.

If the location policy is compatible with the device policy at 1308 (e.g., if both policies indicate that the wireless communication device should be allowed to send and receive data), information is transmitted to arrange for the wireless communication device to communicate in accordance with the location policy and the device policy at 1312. For example, the location device 1000 may transmit information to a mobile user device 400 to be stored as a current user device policy identifier 906.

If the location policy is not compatible with the device policy at 1308, the two policies are reconciled at 1310. For example, the location device 1000 and the wireless communication device may exchange information to negotiate a modified policy that is acceptable to both a user and a party associated with the location. After the policies are reconciled at 1310, information is transmitted to arrange for the wireless communication device to communicate in accordance with the location policy and the device policy at 1312. For example, the location device 1000 may transmit a modified policy to a mobile user device 400 to be stored via the user device policy 804 and the current user device policy identifier 906.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some of the embodiments described herein have a location device 1000 arrange for a mobile user device 400 to operate in accordance with a location policy, according to another embodiment mobile user devices 400 communicate with each other to perform this function (e.g., mobile user devices 400 may utilize peer-to-peer communications to arrange for all device to operate in an acceptable manner). For example, a number of portable music players might communicate to ensure that devices do not interfere with each other (e.g., by playing music too loudly).

Moreover, many of the embodiments described herein arrange for a mobile user device 400 to operate in accordance with a location policy and/or user device information. According to another embodiment, however, the operation of a location device 1000 (i.e., instead of a mobile user device) is controlled instead.

Note that embodiments of the present invention are applicable to many different types of locations. For example, a location may be mobile and/or temporary, such as an emergency zone established by a police department or a parade zone that moves along a pre-determined route. Moreover, a location can be associated with many different types of authorities (e.g., a library, a retail store, a government, or a casino).

In addition, the policies that are illustrated herein, and any number of other types of policies may be used in accordance with the present invention. For example, a policy may be based in part on the content of information received by (or transmitted to) a mobile user device 400 (e.g., a location device 1000 could analyze text information or image information to determine if a particular electronic mail message can be received by a mobile user device 400 at a particular location).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating operation of a mobile user device at a location, comprising:
determining a location policy associated with the location;
determining user device information associated with the mobile user device; and
arranging for the mobile user device to operate in accordance with the location policy and the user device information.

2. The method of claim 1, wherein said determining the location policy comprises at least one of: (i) retrieving a pre-stored location policy, (ii) receiving an indication of the location policy from a location device, (iii) evaluating a plurality of potential location policies, and (iv) receiving an indication of the location policy via a third-party service device.

3. The method of claim 2, wherein the indication of the location policy comprises at least one of: (i) the location policy, (ii) a location identifier, (iii) a policy identifier, (iv) a pointer to a location policy, and (v) payment information.

4. The method of claim 1, wherein the user device information comprises at least one of: (i) information associated with the mobile user device, (ii) information associated with a user, (iii) a user device policy, (iv) a policy identifier, (v) a user device identifier, (vi) a user identifier, (vii) a user category, and (viii) payment information.

5. The method of claim 1, wherein said determining the user device information comprises at least one of: (i) retrieving pre-stored user device information, (ii) receiving an indication of the user device information from the mobile user device, and (iii) receiving an indication of the user device information via a third-party service device.

6. The method of claim 1, wherein said arranging further comprises:
comparing the location policy with the user device information.

7. The method of claim 1, wherein said arranging further comprises:
determining whether to apply the location policy based on the user device information.

8. The method of claim 1, wherein said arranging further comprises:
negotiating a policy to be applied by the mobile user device.

9. The method of claim 1, further comprising:
verifying that the mobile user device operates in accordance with the location policy and the user device information.

10. The method of claim 1, further comprising:
arranging for a user to receive a notification associated with operation of the mobile user device in accordance with the location policy and the user device information.

11. The method of claim 1, where in the location is associated with at least one of: (i) proximity to a location device, (ii) a location boundary, (iii) a mobile location, (iv) a plurality of locations, (v) an event time, (vi) an event area, (vii) an education area, and (viii) a health care area.

12. The method of claim 1, wherein the mobile user device comprises at least one of: (i) a mobile computing device, (ii) a personal digital assistant, (iii) a communication device, (iv) a wireless telephone, (v) a pager, (vi) an information storage device, (vii) an audio recording device, and (viii) an image recording device.

13. The method of claim 1, wherein operation of the user device is associated with communication via at least one of: (i) a wireless network, (ii) a wireless local area network, (iii) an infrared radiation network, (iv) a communication network, (v) a Bluetooth network, and (vi) an 802.11 network.

14. The method of claim 1, wherein said arranging is performed by a location device.

15. The method of claim 1, wherein said arranging is performed by the mobile user device.

16. The method of claim 1, wherein said arranging is performed by a third-party service device.

17. The method of claim 1, further comprising:
arranging for a third-party service to exchange payment associated with at least one of: (i) a user and (ii) a location.

18. The method of claim 1, wherein the operation of the mobile user device is associated with at least one of: (i) receiving information, (ii) storing information, (iii) transmitting information, and (iv) providing information to a user.

19. A computer-implemented method of facilitating operation of a wireless communication device at a location, comprising:
establishing a location policy associated with the location;
receiving a device policy from the wireless communication device;
comparing the location policy with the device policy; and
transmitting information to arrange for the wireless communication device to communicate in accordance with the location policy and the device policy.

20. An apparatus, comprising:
a processor; and
a storage device in communication with said processor and storing instructions adapted to be executed by said processor to:
determine a location policy associated with a location;
determine user device information associated with a mobile user device; and
arrange for the mobile user device to operate in accordance with the location policy and the user device information.

21. The apparatus of claim 20, wherein said storage device further stores at least one of: (i) a user device policy database, (ii) a user device operation status database, (iii) a location policy database, and (iv) a location operation status database.

22. The apparatus of claim 20, further comprising:
a communication device coupled to said processor and adapted to communicate with at least one of: (i) a user device, (ii) a location device, (iii) a third-party service device, and (iv) a payment device.

23. A medium storing instructions adapted to be executed by a processor to perform a method of facilitating operation of a mobile user device at a location, said method comprising:
determining a location policy associated with the location;
determining user device information associated with the mobile user device; and
arranging for the mobile user device to operate in accordance with the location policy and the user device information.

24. A method of facilitating operation of a mobile user device at a location, comprising:
determining a user device policy associated with the mobile user device;
determining location information associated with the location; and
arranging for the mobile user device to operate in accordance with the user device policy and the location information.

25. A method of facilitating operation of a mobile user device at a location, comprising:
determining a location policy associated with the location;
determining a user device policy associated with the mobile user device; and
arranging for the mobile user device to operate in accordance with at least one of: (i) the location policy, and (ii) the user device policy.

26. A method performed by a third-party service to facilitate operation of a mobile user device at a location, comprising:
receiving an indication of a location policy associated with the location;
receiving user device information associated with the mobile user device; and
transmitting information to arrange for the mobile user device to operate in accordance with the location policy and the user device information.

27. The method of claim 26, wherein the user device information comprises location information.
